(19) United States
(12) Patent Application Publication
(10) Pub. No.: US 2015/0352584 A1
(43) Pub. Date: Dec. 10, 2015

(54) HIGH-PRESSURE CLEANING INSTRUMENT AND CLEANING MEASUREMENT

(71) Applicant: Scholly Fiberoptic GmbH, Denzlingen (DE)

(72) Inventors: Marcus Franz, Bad Krozingen-Biengen (DE); Klaus Wolter, Bad Krozingen (DE); Matthias Kratschmer, Freiburg (DE); Jochen Dietrich, Elzach (DE); Claas Muller, Freiburg (DE); Holger Reinecke, Emmendingen (DE)

(73) Assignee: SCHOLLY FIBEROPTIC GMBH, Denzlingen (DE)

(21) Appl. No.: 14/728,217

(22) Filed: Jun. 2, 2015

(30) Foreign Application Priority Data
Jun. 4, 2014 (DE) 102014008187.7

(51) Int. Cl. B05B 15/08; B08B 3/02

(52) U.S. Cl. CPC B05B 15/08; B08B 3/02

(57) ABSTRACT

In the case of a high-pressure cleaning instrument (1), it is proposed to form a flexible portion (7) of a liquid passage (3) between an instrument tip (4) and an operating end (19) in links (8, 9, 10) which are connected to one another in an articulated manner, wherein adjacent links (8, 9, 10) are connected to one another via at least one joint (11, 21) in each case and each have a pressure-application surface (14, 27) on a joint head (15, 24), with which pressure application surface the respective at least one joint (11, 21) is fixed or can be fixed in the liquid passage (3) in a pressure-dependent manner by an internal pressure.

### INCORPORATION BY REFERENCE

The following documents are incorporated herein by reference as if fully set forth: German Patent Application 10 2014 008 187.7, filed Jun. 4, 2014.

### BACKGROUND

The invention relates to a high-pressure cleaning instrument with a liquid passage which opens outwards at an instrument tip via a nozzle.

The invention further relates to a cleaning method.

High-pressure cleaning instruments are used in order to clean an object to be cleaned with a liquid under high pressure, for example at a cleaning point.

### SUMMARY

The invention is based on the object of providing a high-pressure cleaning instrument of the type described, with which a cleaning method can be carried out on parts which are otherwise difficult to access.

This object is met using one or more features of the invention. According to the invention, in the case of a high-pressure cleaning instrument of the type described at the beginning, it is therefore proposed in particular that a portion of the liquid passage is formed in a first link and in a second link, which links are connected in an articulated manner to each other via at least one joint, that the at least one joint has a joint socket and a joint head which is mounted in the latter, that a pressure-application surface to which an internal pressure in the liquid passage can be applied or is applied is formed on the joint head, and that the joint head acts upon the joint socket in a pressure-dependent manner.

It can thereby be achieved that the liquid transported in the liquid passage has the effect, owing to the internal pressure which is developed, of fixing the joint by the joint head being fixed non-positively or even positively at the joint socket. This internal pressure can arise, for example, by a build-up at the nozzle.

For this purpose, the joint head has a pressure-application surface which is wetted by the liquid in the liquid passage and via which the internal pressure in the liquid passage provides a press-on or retaining force with which the joint head is fixed in the joint socket.

A flexible cleaning instrument is therefore provided which can be introduced into a cavity to which access is difficult, wherein a position or orientation of the at least one joint can be fixed by applying a working pressure to the liquid passage, i.e. after introduction into the cavity. After the end of the cleaning method, the fixing of the at least one joint can be released again by, for example, the internal pressure in the liquid passage being reduced.

In a refinement of the invention, it can be provided that a joint socket of the at least one joint is formed on the first link. It is of advantage here that the joint head can be accommodated or is accommodated on the first link. The at least one joint can therefore be provided with an abutment which enables the at least one joint to be fixed in a manner particularly capable of bearing a load. The joint socket is preferably formed releasably on the first link. It is of advantage here that the installation of the high-pressure cleaning instrument can be simplified. This is because, after the intermediate piece is installed, the joint socket can be connected on the latter to the first link. For example, the joint socket can be designed so as to be screwable to the first link.

In a refinement of the invention, it can be provided that a spring element acts upon a fixing element contacting the joint head. It is of advantage here that the joint head can be held in a sealing position, for example in a standby or working position. The spring element is preferably oriented in such a manner that a pressure application by the spring element reinforces the pressure application by the internal pressure. The joint head can therefore be held in the standby or working position even when the internal pressure decreases. A refinement which is particularly space-saving and/or can be mounted particularly simply can make provision for the spring element to be arranged in the liquid passage. The spring element can act here, for example, upon the pressure application surface (already described) of the joint head—preferably via the fixing element mentioned.

In a refinement of the invention, it can be provided that there is at least one cable pull which is guided to an operating end of the high-pressure cleaning instrument and with which an adjustable angle of the at least one joint can be adjusted. It is of advantage here that an orientation of the first link with respect to the second link can be controlled from a distance. Said cable pull can be subjected, for example, to a tensile and to a shearing stress, and therefore a 2-way control can be achieved with a single cable pull. However, it is also possible to form two cable pulls which can each be subjected to a tensile and compression and shearing stress in order to realize a 4-way control.

In a refinement of the invention, it can be provided that the adjustable angle of the at least one joint can be adjusted with at least one individually assigned cable pull, in particular with at least two cable pulls. It is of advantage here that a separate pivoting or angling of the links, for example in one plane, can be implemented. For example, a 2-way control can be realized. It is particularly favourable if the at least one joint is assigned more than two cable pulls, for example three cable pulls or four cable pulls. It is of advantage here that an orientation or orientability of the links with respect to one another can be realized in any direction in space, for example in the form of a 4-way control.

In a refinement of the invention, it can be provided that the portion of the liquid passage is formed in a plurality of links which are connected in an articulated manner to one another via at least one joint in each case. A flexible portion of the high-pressure cleaning instrument can therefore be formed. The links and/or the joints are preferably of similar or identical design to one another.

In this connection, it can be provided, in a refinement of the invention, that each pair of links connected in an articulated manner to one another is in each case assigned at least one cable pull which is guided to an operating end of the high-pressure cleaning instrument and with which an adjustable angle of the links of the pair can be adjusted individually. It is of advantage here that a multiplicity of different shapes of the flexible portion can be adjusted.

In a refinement of the invention, it can be provided that the first link is connected to the second link by an intermediate piece. The second link can therefore be arranged at a distance from the first link. An increased adjustable range of an angle of the links with respect to one another can be achieved.

In this connection, in a refinement of the invention, it can be provided that the intermediate piece forms or receives a portion of the liquid passage. It is of advantage here that the intermediate piece can additionally carry out a protective function for the liquid passage.

A double joint can thus be formed, wherein the intermediate piece connects the joints of the double joint.

Alternatively or additionally, it can be provided here that the intermediate piece is arranged in an uncontrolled and/or unactuable manner between the first link and the second link. Alternating sequences of controlled links and intermediate pieces which are uncontrolled, i.e. are moveable at the same time, can therefore be strung together. Particularly flexible and readily controllable chains of links can thus be formed.

In a refinement of the invention, it can be provided that the joint head of the at least one joint is formed on the intermediate piece. A structurally simply configured intermediate piece can therefore be used.

It is particularly favourable here if the joint head is formed in a releasably connectable manner on the intermediate piece. Installation can therefore be simplified. The intermediate piece can be inserted into a, for example, annular or sleeve-shaped joint socket, and the joint head can subsequently be mounted. For example, the joint head can be screwed onto the intermediate piece.

In a refinement of the invention, it can be provided that the at least one joint connects the intermediate piece to the first link. The intermediate piece is therefore movable relative to the first link.

In a refinement of the invention, it can be provided that the at least one joint is a first joint, and a second joint connects the intermediate piece to the second link. The intermediate piece is therefore movable relative to the second link. If the intermediate piece is connected both to the first link and to the second link via a respective joint, a large adjustable range for an angle or an angling between the first link and the second link can be achieved. A double joint can thus be formed, said double joint connecting the first link to the second link in an articulated manner.

In a refinement of the invention, it can be provided in this connection that a joint socket of the second joint is arranged on the second link. It is of advantage here that a robust abutment can be formed for the second joint. The joint socket is preferably of annular or sleeve-shaped design, wherein the intermediate piece can be inserted through the joint socket. A large internal pressure can thus be accommodated in the liquid passage. The joint socket is preferably integrally formed on the second link. Manufacturing of the second link can therefore be simplified.

Alternatively or additionally, it can be provided here or in a further refinement that a joint head of the second joint is formed on the intermediate piece. A structurally simple intermediate piece can therefore be used. It is particularly favourable here if the joint head is formed in a releasably connectable manner on the intermediate piece. It is of advantage here that the joint head can be mounted after the intermediate piece has been inserted into a joint socket. The intermediate piece preferably has a respective joint head at mutually opposite ends in order to be able to form the first joint and the second joint, and is, for example, of dumbbell-shaped design, in particular with the joint heads forming thickened portions of dumbbell shape at the ends.

In a refinement of the invention, it can be provided that a joint with a joint head is formed on the second link, and that a second pressure application surface is formed on the joint head of the second joint, to which pressure application surface the internal pressure in the liquid passage can be applied or is applied, wherein the joint head of the second joint acts upon a joint socket of the second joint, in particular the joint socket which has already been mentioned, in a pressure-dependent manner. The second joint can therefore also be fixed in the liquid passage by a working pressure as the internal pressure. It is particularly favourable if the pressure application surface is directly in contact with the or a liquid in the liquid passage. By means of a spring element and a fixing element, the joint head can be held in a standby or working position in the manner described even when working pressure is lacking.

In a refinement of the invention, it can be provided that the first link and/or the second link are/is in each case of sleeve-shaped design. A structurally simple construction can therefore be used. It is particularly favourable if the fixing element or the fixing elements is/are in each case of annular or sleeve-shaped design. The liquid passage can therefore be guided through the fixing element or the fixing elements.

In order to achieve movability in one plane, the at least one joint and/or the second joint can be designed, for example, as a hinge joint or cylinder joint.

In a refinement of the invention, it can be provided that the at least one joint is designed as a ball-and-socket joint. Movability of the links with respect to one another in a solid angle can therefore be arranged.

Alternatively or additionally, it can be provided that the second joint is designed as a ball-and-socket joint. Great movability of the second link relative to the intermediate piece in a solid angle can therefore be achieved. It is particularly favourable if two joints which are coupled via the intermediate piece are formed between the first link and the second link, for example in the form of a double joint. By this means, great flexibility of the connection between the first link and the second link can be achieved.

In a refinement of the invention, it can be provided that a joining means for joining a liquid-conveying device to the liquid passage is formed at an operating end, for example at the already mentioned operating end, of the high-pressure cleaning instrument. It is of advantage here that a liquid can be poured into the liquid passage outside a cavity, into which a flexible part of the high-pressure cleaning apparatus has been introduced. The joining means can be designed here for the releasable or fixed connection to the liquid-conveying device.

In a refinement of the invention, it can be provided that an actuating device for actuating the at least one cable pull is formed at the or at an operating end of the high-pressure cleaning instrument. It is of advantage here that a profile of a flexible portion can be controlled from outside a cavity, into which the flexible portion has been introduced.

In a refinement of the invention, it can be provided that at least one portion of a working passage running to the instrument tip is formed on the first link and the second link. For example, the at least one working passage can accommodate an optical waveguide for an illumination at the instrument tip or for image recording by the instrument tip, or another working line. Alternatively or additionally, the at least one working passage can accommodate electrical connecting means for an illuminating means and/or for an image recording sensor at the instrument tip. Finally, the at least one working passage can be designed for accommodating additional instruments.

It is therefore of advantage that different types of working lines, for example electrical connecting means, optical waveguides, endoscopic instruments, or a plurality of similar such working lines, can be accommodated at the same time. The working passages in the at least one portion are preferably guided parallel to one another and/or at a constant distance from one another.

In particular, it can be provided here that at least two working passages are formed, and a working line, in particular an electrical connecting means, an optical waveguide and/or an endoscopic instrument, is accommodated in each of the at least two working passages, and is guided in a manner crossing one another at the at least one joint. It is of advantage here that formation of loops of loose working lines with joints at pronounced angles can be avoided.

A particularly simple refinement can make provision for the liquid passage to be formed in a tubeless manner in the links and the intermediate pieces.

Furthermore, according to the invention, in order to achieve the object mentioned, the features of the further independent claim, which is directed towards a cleaning method, are proposed. In particular, it is therefore provided according to the invention in a cleaning method that a high-pressure cleaning instrument having at least two links which are connected in an articulated manner to one another and accommodate or form a portion of a liquid passage, for example the first link which has already been described and the second link which has likewise been described, for example, as described previously and/or according to one of the claims directed towards a high-pressure cleaning instrument, is placed through an opening into a cavity, wherein the at least two links are oriented with respect to one another in order to orient a nozzle arranged in an instrument tip at a cleaning point, and wherein an internal pressure is subsequently applied to the liquid passage, by means of which the at least two links are fixed relative to one another. It is of advantage here that a flexible high-pressure cleaning instrument can be fixed automatically and at a cleaning point which is difficult to access by a working pressure being applied to the liquid passage.

In a refinement of the invention, it can be provided that the at least two links are oriented with respect to one another by means of at least one cable pull. It is of advantage here that an orientation of the links can be carried out remotely, for example from outside the cavity to be cleaned. The high-pressure cleaning instrument can therefore be adapted to an internal geometry of a cavity and can be fixed during normal operation, in which a working pressure prevails in the liquid passage. The two joints are preferably oriented with respect to each other from an operating end, for example the operating end already mentioned, by means of the at least one cable pull. It is particularly favourable if the high-pressure cleaning instrument has a plurality of links, in particular in the manner already described, which can be oriented with respect to one another separately from one another, i.e. for example individually. It is therefore possible to set virtually any or at least diverse courses and/or orientations of a flexible portion of the high-pressure cleaning instrument. Complicated internal geometries are thus easily accessible.

It is particularly favourable if, in the method according to the invention, a high-pressure cleaning instrument according to the invention is used.

### BRIEF DESCRIPTION OF THE DRAWINGS

The invention is now described in more detail with reference to an exemplary embodiment, but is not restricted to said exemplary embodiment. Further exemplary embodiments emerge from combining the features of individual claims or a plurality of claims with one another and/or with individual features or a plurality of features of the exemplary embodiment.

In the drawings:

FIG. 1 shows a highly simplified illustration of a high-pressure cleaning instrument according to the invention,

FIG. 2 shows a detailed view of a connection of two links of the high-pressure cleaning instrument according to FIG. 1,

FIG. 3 shows a sectional view of two links, which are connected in an articulated manner to each other, of the high-pressure cleaning instrument according to FIG. 1, and

FIG. 4 shows a partially cut-open illustration of the instrument tip of the high-pressure cleaning instrument according to FIG. 1.

### DETAILED DESCRIPTION OF THE EMBODIMENTS

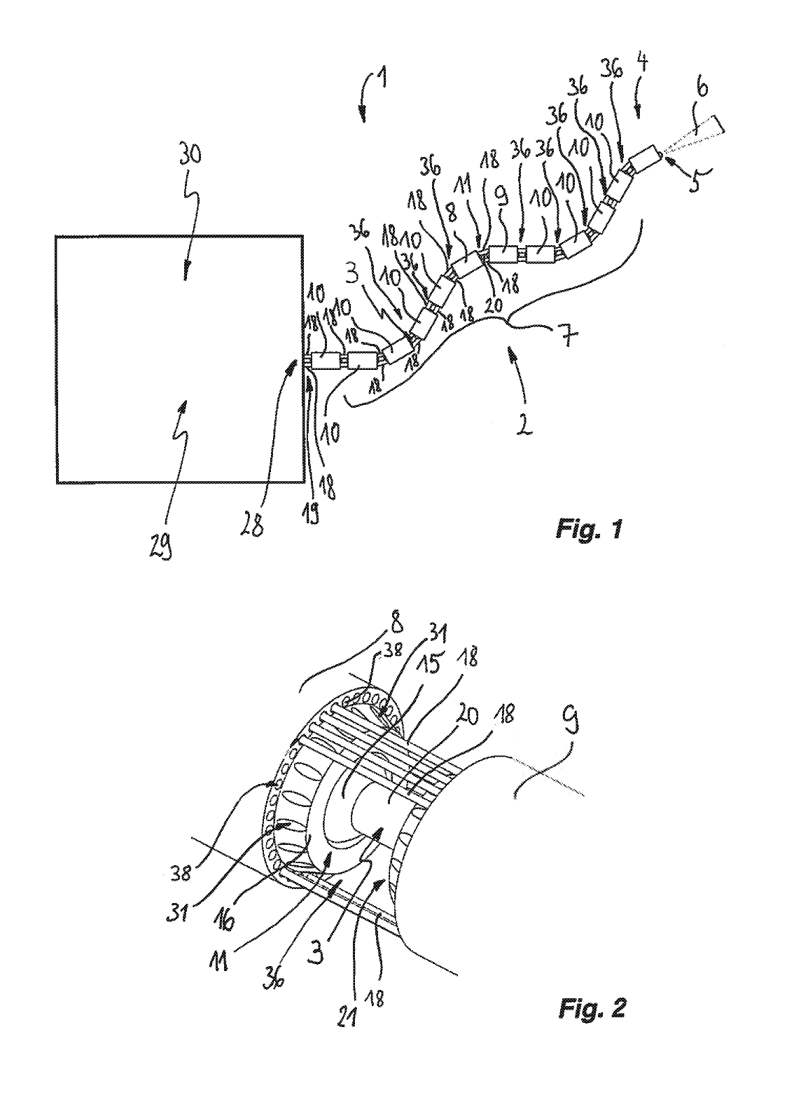

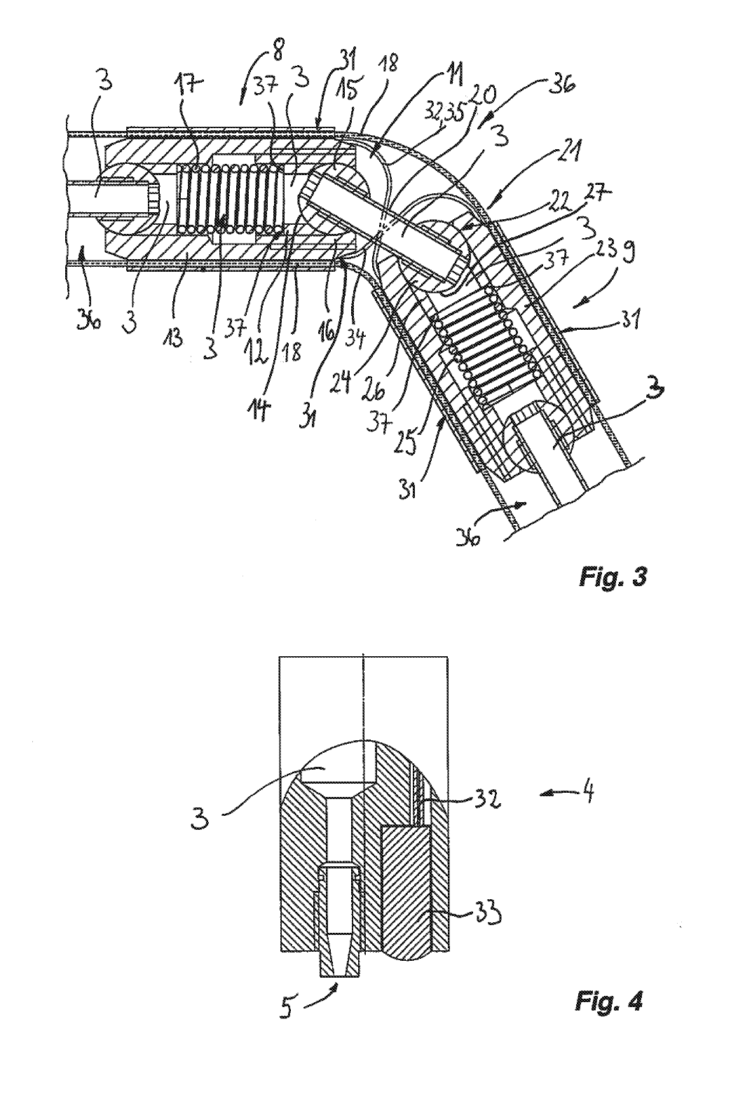

A high-pressure cleaning instrument according to the invention, denoted overall by 1 in FIG. 1, has a flexible portion 2, in the interior of which a liquid passage 3, shown in more detail in FIGS. 3 and 4, for transporting a liquid, for example a cleaning liquid, to the instrument tip 4 is formed.

At the instrument tip 4, the liquid passage 3 opens outwards via a nozzle 5, shown in more detail in FIG. 4, visible here by way of a constriction of an internal cross section of the liquid passage 3.

During the operation, the nozzle 5 therefore produces an emerging liquid jet 6 which can be used and is used at cleaning points for cleaning surfaces, for example, in cavities.

A flexible portion 7 of the liquid passage 3 is formed in a first link 8 and in a second link 9 and in further links 10.

The first link 8 is connected in an articulated manner to the second link 9 via at least one joint 11. Respectively adjacent links 10 are connected to one another and to the first link 8 and the second link 9 likewise in an articulated manner.

The at least one joint 11 has a fixing element 12 which is of sleeve-shaped design and arranged moveably relative to a basic body 13 of the first link 8. The at least one joint 11 has a joint head 15 which is mounted moveably in a joint socket 16.

A pressure application surface 14 is formed on the joint head 15 towards the liquid passage 3, which pressure application surface 14 can be wetted by a liquid in the liquid channel 3. The joint head 15 is therefore acted upon by an internal pressure in the liquid passage 3, as a result of which said joint head is pressed onto the joint socket 16 of the at least one joint 11. By means of this pressure-dependent action upon the joint head 15, the at least one joint 11 is fixed frictionally.

In this connection, the joint socket 16 of the at least one joint 11 forms an abutment for the joint head 15 during the pressurization mentioned.

It is apparent in FIG. 3 that the annular or sleeve-shaped joint socket 16 is screwed into the basic body 13 of the first link and is therefore formed releasably on the first link 8.

The annular or sleeve-shaped joint socket 16 accommodates the annular or sleeve-shaped fixing element 12 in a sliding manner here.

A spring element 17, for example a helical spring, acts upon the fixing element 12 on an annular surface 37 and keeps said fixing element in the depicted standby or working position even after a drop in pressure in the liquid passage 3. In this case, the spring element 17 acts—via the fixing element 12—on the joint head 15 in the same direction as the internal pressure in the liquid passage 3 and at least slightly reinforces said internal pressure.

The at least one joint 11 is assigned cable pulls 18 with which the at least one joint 11 can be controlled in such a manner that any angling or any adjustable angle of the first link 8 relative to the second link 9 within a solid angle can be set. In actual fact, in the exemplary embodiment shown, the at least one joint 11 is assigned more than two cable pulls 18, for example four cable pulls 18, in order to realize a 4-way control. In the exemplary embodiment, the cable pulls 18 are capable of bearing a tensile load and are therefore arranged in pairs for each degree of adjustment freedom. Alternatively, use can also be made of cable pulls 18 which can be subjected to a tensile and to a shearing stress, as a result of which only one cable pull is required per degree of adjustment freedom.

The cable pulls 18 are guided in guides 38 to an operating end 19 of the high-pressure cleaning instrument 1 in order to permit individual actuation or orientation of the at least one joint 11.

As already mentioned, the portion 7 of the liquid passage 3 between the operating end 19 and the instrument tip 4 is formed in a plurality of links 10 which are connected in an articulated manner to one another. The respectively adjacent links 8, 9, 10 are connected here to one another via at least one joint 11 in a similar or identical manner to the first link 8 and the second link 9. Each pair of links 8, 9, 10 connected in an articulated manner to one another is assigned a respective set of cable pulls 18. Via the latter, in each case precisely the adjustable angle of the relevant links 8, 9, 10 of the pair to which the cable pulls 18 are assigned can be adjusted individually, i.e. independently of the remaining links 8, 9, 10.

It is apparent in FIGS. 2 and 3 that the first link 8 is connected to the second link 9 by an intermediate piece 20. The intermediate piece 20 is likewise of sleeve-shaped design and, in the interior thereof, forms a portion or part of the liquid passage 3.

No cable pulls act upon the intermediate piece 20. The latter is of uncontrolled design and is merely moved along with an adjustment movement of the first link 8 relative to the second link 9.

The joint head 15 of the at least one link 11 is screwed to the intermediate piece 20 and is therefore designed to be releasable from the latter. The at least one link 11 therefore connects the intermediate piece 20 to the first link 8.

At that end of the intermediate piece 20 which faces away from the at least one joint 11 as the first joint, said intermediate piece is connected to the second link 9 via a second joint 21.

The second joint 21 is formed analogously to the first joint 11 and therefore likewise has a joint socket 22 which, however, is moulded onto or is integrally formed on a basic body 23 of the second link 9.

A joint head 24 of the second joint 21 is screwed to the intermediate piece 20 or is releasably connected thereto in some other manner.

A spring element 25 likewise acts upon an annular or sleeve-shaped fixing element 26, on the annular surface 37 thereof, said fixing element being arranged in a sliding manner in the basic body 23 of the second link 9.

By means of the spring element 25, the fixing element 26 holds the joint head 24 in a standby or working position.

The internal pressure in the liquid passage 3 acts upon the annular second pressure application surface 27 of the joint head 24, as a result of which the latter is pressed in a pressure-dependent manner against the associated joint socket 22. The second joint 21 is therefore likewise held at least frictionally as long as the internal pressure is high enough.

The first link 8 and the second link 9 are in each case of sleeve-shaped design with sleeve-shaped basic bodies 13, 23 which form the liquid passage 3 inside themselves.

The joint heads 15, 24 are shaped spherically, and therefore the joints 11, 21 in each case form a ball-and-socket joint. The intermediate piece 20 with the joint heads 15, 24, which are designed as thickened portions at the ends of the intermediate piece, is therefore of dumbbell-shaped configuration.

For the installation, first of all the intermediate piece 20 with the joint head 24 of the second joint screwed thereon or connected thereto is inserted through the basic body 23 of the second link 9 and the joint socket 22 of the second joint 21. The joint socket 16 of the first joint 11 is subsequently placed onto the intermediate piece 20, and the joint head 15 is connected to the intermediate piece 20 and inserted into the basic body 13, in which a joint head of a further joint, the spring element 17 and the fixing element 12 are already located. The annular or sleeve-shaped joint socket 16 of the first joint 11 is then connected, for example screwed, to the basic body 13 of the first link 8.

The joints 11, 21 therefore form a double joint 36, and the next double joint 36 can be installed in the same manner.

The further links 10 here are of identical design to the links 8, 9 described, in order to form a respective double joint 36. Each double joint 36 is assigned an individual set of cable pulls 18.

A joining means 28 via which a liquid-conveying device 29, which is not illustrated specifically and is known per se, for example a pump, for the liquid is joined to the liquid passage 3, is formed at the operating end 19 of the high-pressure cleaning instrument 1.

The high-pressure cleaning instrument 1 has an actuating device 30, which is not illustrated specifically and is known per se, for example in the form of adjustable levers, with which actuating device the cable pulls 18 are actuable individually or in a coordinated manner in order to achieve a desired change in shape or design of the flexible portion 7.

Portions of working passages 31 running to the instrument tip 4 are in each case formed in addition to the liquid passage 3 at the links 8, 9, 10. A working line, for example an electrical connecting means 32, for example a connecting line, is in each case guided in said working passages 31 to the instrument tip 4, in order to supply an illuminating means, here, for example, an LED lighting apparatus. Alternatively or additionally, the electrical connecting means 32 can be set up for operating a visualization means 33, for example a miniaturized video camera with an image recording sensor in the instrument tip 4.

Other working lines, for example an optical waveguide 34, for recoding images for the instrument tip 4 can also be arranged in the working passages 31. The optical waveguides 34 can also be used instead of the illuminating means mentioned in order to illuminate a cavity or a surface to be cleaned.

The working passages 31 can also accommodate further working lines, such as endoscopic instruments 35, and guide same to the instrument tip 4.

The working lines are guided in a manner crossing one another at the at least one joint 11. For this purpose, in each case one working line, for example the optical waveguide 34 or the endoscopic instrument 35, changes side with a further working line, for example the electrical connecting means 32, level with the at least one joint 11 or between the first link 8 and the second link 9. The effect is therefore achieved that no excessively large adjustment paths are required for angling the at least one joint 11 and that no excessively large loops due to loose cable pulls 18 form during the angling.

It is also apparent in FIG. 3 that the liquid passage 3 is formed tubelessly in the links 8, 9, 10 and in the intermediate pieces 20.

For the operation, in the case of the cleaning method according to the invention, the instrument tip 4 with the links 8, 9, 10, which form the flexible portion 7 of the up to now pressureless liquid passage 3, is placed through an opening into a cavity.

The links 8, 9, 10 are oriented here with respect to one another individually from the operating end 19 by means of cable pulls 18 in order to orient a nozzle 5 arranged on the instrument tip 4 at a cleaning point. This can take place, for example, during the insertion or after the insertion through the opening.

An internal pressure is subsequently applied to the liquid passage 3, by means of which the pressure application surfaces 14, 27 of each double joint 36 are acted upon in such a manner that the respective joints 11, 21 and therefore the associated links 8, 9, 10 are fixed relative to one another.

After the internal pressure decreases, the joints 11, 21 are released again, and therefore the portion 7 can be pulled out of the opening.

In the case of a high-pressure cleaning instrument 1, it is proposed to form a flexible portion 7 of a liquid passage 3 between an instrument tip 4 and an operating end 19 in links 8, 9, 10 which are connected to one another in an articulated manner, wherein adjacent links 8, 9, 10 are connected to one another via at least one joint 11, 21 in each case and in each case have a pressure-application surface 14, 27 on a joint head 15, 24, with which pressure application surface the respective at least one joint 11, 21 is fixed or can be fixed in the liquid passage 3 in a pressure-dependent manner by an internal pressure.

1. A high-pressure cleaning instrument (1) comprising: a liquid passage (3) which opens outwards at an instrument tip (4) via a nozzle (5), a first link (8) and a second link (9), in which a portion (7) of the liquid passage (3) is formed, said first and second links are connected in an articulated manner to each other via at least one joint (11), the at least one joint (11) has a joint socket (16) and a joint head (15) which is mounted in the joint socket, a pressure-application surface (14) to which an internal pressure in the liquid passage (3) is applied is formed on the joint head (15), and the joint head (15) acts upon the joint socket (16) in a pressure-dependent manner.

2. The high-pressure cleaning instrument (1) according to claim 1, wherein the joint socket (16) of the at least one joint (11, 21) is formed on the first link (8).

3. The high-pressure cleaning instrument (1) according to claim 1, further comprising at least one cable pull (18) which is guided to an operating end (19) of the high-pressure cleaning instrument (1) and with which an adjustable angle of the at least one joint (11) can be adjusted.

4. The high-pressure cleaning instrument (1) according to claim 3, wherein the adjustable angle of the at least one joint (11) is adjustable by at least one individually assigned one of the cable pulls.

5. The high-pressure cleaning instrument (1) according to claim 1, wherein the portion (7) of the liquid passage (3) is formed in a plurality of the links (8, 9, 10), including the first and second links, which are each connected to an adjacent of the links in an articulated manner via respective ones of the joints (11), and each pair of the links (8, 9, 10) that are connected to one another in an articulated manner is in each case assigned at least one cable pull (18) which is guided to an operating end (19) of the high-pressure cleaning instrument (1) and with which an adjustable angle of the links (8, 9, 10) of the pair can be adjusted individually.

6. The high-pressure cleaning instrument according to claim 1, wherein the first link (8) is connected to the second link (9) by an intermediate piece (20), and the intermediate piece (20) forms or receives a portion of the liquid passage (3).

7. The high-pressure cleaning instrument (1) according to claim 6, wherein the joint head (15) of the at least one joint (11) is formed on the intermediate piece (20).

8. The high-pressure cleaning instrument (1) according to claim 6, wherein the at least one joint (11) is a first joint, and a second joint (21) connects the intermediate piece (20) to the second link (9), with a joint socket (22) of the second joint (21) arranged on the second link (9).

9. The high-pressure cleaning instrument (1) according to claim 1, wherein a second joint (21) with a joint head (24) is formed on the second link (9), and a second pressure-application surface (27) is formed on the joint head (24) of the second joint (21), to which pressure-application surface internal pressure in the liquid passage (3) is applied, and the joint head (24) of the second joint (21) acts upon a joint socket (16) of the second joint (21) in a pressure-dependent manner.

10. The high-pressure cleaning instrument (1) according to claim 1, wherein at least one of the first link (8) or the second link (9) are sleeve-shaped, and the at least one joint (11) is a ball-and-socket joint.

11. The high-pressure cleaning instrument (1) according to claim 1, further comprising a connector (28) that joins a liquid-conveying device (29) to the liquid passage (3).

12. The high-pressure cleaning instrument (1) according to claim 1, wherein at least one portion of at least one working passage (31) running to the instrument tip (4) is formed on the first link (8) and the second link (9), and a working line, is accommodated in the at least one working passage (31) and is guided in a manner crossing one another at the at least one joint (11).

13. A cleaning method comprising: providing a high-pressure cleaning instrument (1) having at least two links (8, 9, 10) which are connected in an articulated manner to one another and receive or form a portion (7) of a liquid passage (3) according to claim 1, placing the instrument tip through an opening into a cavity, orienting the at least two links (8, 9, 10) with respect to one another in order to orient a nozzle (5) arranged at the instrument tip (4) at a cleaning point, and subsequently applying an internal pressure to the liquid passage (3), by which the at least two links (8, 9, 10) are fixed relative to one another.

14. The cleaning method according to claim 13, wherein the at least two links (8, 9, 10) are oriented with respect to one another by at least one cable pull (18) from an operating end (19).

15. The high-pressure cleaning instrument (1) according to claim 1, wherein a spring element (17) acts upon a fixing element (12) contacting the joint head (15).

16. The high-pressure cleaning instrument (1) according to claim 1, wherein the first link (8) is connected to the second link (9) by an intermediate piece (20), and the intermediate piece (20) forms a double joint (36).

17. The high-pressure cleaning instrument (1) according to claim 1, wherein the first link (8) is connected to the second link (9) by an intermediate piece (20), and the intermediate piece (20) is arranged in an uncontrolled or unactuable manner between the first link (8) and the second link (9).

18. The high-pressure cleaning instrument (1) according to claim 6, wherein the at least one joint (11) connects the intermediate piece (20) to the first link (8).

19. The high-pressure cleaning instrument (1) according to claim 8, wherein a joint head (24) of the second joint (21) is formed on the intermediate piece (20).

20. The high-pressure cleaning instrument (1) according to claim 1, further comprising an actuating device (30) for actuating the at least one cable pull (18) formed at an operating end (19) of the high-pressure cleaning instrument (1).
